(19) United States
(12) Patent Application Publication
(10) Pub. No.: US 2012/0238350 A1
(43) Pub. Date: Sep. 20, 2012

(54) SONG LYRICS GAME FOR AN ELECTRONIC DEVICE

(75) Inventors: Amnon Sarig, Woodland Hills (CA); Ran Cohen, Tel Aviv (IL)

(73) Assignee: TUNEWIKI Ltd., Tortola (VG)

(21) Appl. No.: 13/105,917

(22) Filed: May 12, 2011

Related U.S. Application Data
(63) Continuation of application No. PCT/IL09/00756, filed on Aug. 3, 2009.
(60) Provisional application No. 61/114,484, filed on Nov. 14, 2008.

(51) Int. Cl. A63F 13/00; A63F 9/24

(52) U.S. Cl. 463/25; 463/31

(57) ABSTRACT

The present invention is a lyrics game playable on an electronic device. A song is played by the device. The game includes showing the lyrics of the song on the screen of the dedicated player, each word in a different bubble and bursting the bubbles by the player, in the right order, at the right time, when the artist sings them, and over the right duration.

### CROSS REFERENCE

This application claims priority from U.S. Provisional Application No. 61/114,484, dated Nov. 14, 2008, entitled “A System and a Method for Lyrics hero Online or Offline Game”, which provisional application is incorporated by reference herein in its entirety. This application is a continuation of, and claims priority from: international application PCT/IL09/000756, filed on 3 Aug. 2009, and published as WO/2010/055501A1, herein incorporated in its entirety by reference.

### FIELD OF THE INVENTION

The present invention relates generally to lyrics games, and more particularly to a method and a system for a competition relative to a series of bubbles with the lyrics of a song or an advertisement, each in a different bubble, and the player needs to burst the bubbles, in the right order, at the right time. The advertising embodiment is used to verify the interaction with of advertising by a player in order to receive other benefits.

### BACKGROUND OF THE INVENTION

Games related to musical skills are known in the art. However, electronic games related to song lyrics are not widely available, for use upon a cellular phone or a PC. It would be advantageous to provide a lyrics game to encourage sales of songs.

### SUMMARY OF THE INVENTION

The invention discloses lyrics game playable on a player handset or PC, wherein an artist or group is singing a song. The method includes showing the lyrics of the song on the screen of the dedicated player, each word in a different bubble and the user must burst the bubbles, in the right order, at the right time, when the artist sings them, and over the right duration, i.e., when the artist or group sings a word for more than 1 second, the player needs to keep pressing the bubble until the artist is done, such that the lyrics game encourages sales of songs and provides exposure for players singing talents.

The user may burst the bubbles using any controls associated with the electronic device. Such controls include: buttons, touch-screen, mouse, keyboard, a joystick, and computer-associated writing tool (e.g. pencil).

The game of the invention is playable on any electronic device having a display screen and having song playback capabilities. Non-limiting examples of electronic devices include: a PC, a laptop, a tablet, a cellular phone, an iPOD™, and a handheld multimedia music player. The term “handset” used in the present invention, is a non-limiting example of one such electronic device. There is no intention to limit the scope invention to a specific electronic device. Rather the scope is determined by the appended claims.

In one embodiment the player can burst the bubbles with the lyrics word in them by SINGING the word. Voice recognition software matches the singing to the lyrics and bursts the bubble for the player without his having to touch the screen.

The present invention is a lyrics game that teaches the player the song lyrics and rhythm in a learning mode, and once mastered, it allows player to compete against any player anywhere in the world.

One embodiment has been developed for the iPhone platform, but the game is also exportable to any operating system, whether Microsoft, Linux or dedicated OS of the Flash platform of Adobe, which enables offering the game on most Nokia Phones as well as on mobile Internet devices (MID's), other mobile computing devices and PC's using the flash platform.

The game is also applicable as a tool for language learning and it will allow players to learn languages through music in a simple way.

Also, the present invention enables pinpointing each word of the lyrics in time. The invention provides for the complete process of appointing a time stamp and using voice recognition software to automatically capture timing details.

### Game Concept:

The game shows the lyrics of the song each, in a different bubble, and the player needs to burst the bubbles, in the right order, at the right time, exactly when the artist sings them, and in the right duration. When the artist sings a word for more than 1 second, the player may or may not keep pressing the bubble until the artist is done.

The present invention can develop a new way to enjoy music. Subscribers listen to music while playing a game. Participation increases one's knowledge of the song, while competing with other players.

The business model is to either sell a set of older songs in a collection for $4.99, for example, or send a new hit, or a new song for $1.99-2.45, for example or provide the song for free and get advertising revenues.

The game of the present invention will bring additional revenue streams to the music labels, artists and applications stores.

Tests with users show remarkable results on how fast they learn the lyrics and the rhythm. Users get to know most of a completely new song within 10 plays, and find it very satisfying to play and sing along with the song.

The competition may be done in 4 ways:

1. On device competition—Divide the screen into 2 players, each taking a side and each one seeing the other one's scores.

2. Organizing a worldwide competition by finding an opponent, wherein players are located listening to the same song on TuneWiki maps and one player challenging the other to play against him

3. Worldwide/Local competitions are automatically organized by location—The player will be identified also by his/her location, and ranked, for example, based on his/her town, country and worldwide position.

4. Worldwide competition is organized by finding an opponent—Locate players with the same song on TuneWiki maps and challenge them to play against you. The proprietary server will ping both of them, and will display to each other the scores of his/her rival. Competitions of up to 4 players or more will be organized. A league will be built that will be local and universal for each song.

In alternative embodiments, the same Lyrics Legend format is designed to include advertising or an experience other then lyrics where: For example, the bubbles have a shape (“Classic Coke” bottles) or colors of Coca Cola and when exploding can burst into Coca Cola logos, icons or any advertising symbols. In another example the lyrics will be actual advertising, and not necessarily a song or a combination with a song, where the incentive of the player will be to play the game to win benefits or ranking.

Alternatively, instead of lyrics in the bubbles there may be icons, either for advertising or, for example, a children's song, where instead of bubbles there are icons or pictures to replace the lyrics, such that players will burst the icon/picture bubble at the right time corresponding to the song or to a story or to an advertisement.

Alternatively, the bubbles are used to learn languages, where the bubbles include the original language or the translation.

Using the same principal, the system can present an advertisement with a song or vocals, and allow interaction by the player with the advertising, making it possible for the advertiser to recognize whether the player is focusing on the advertisement throughout the whole presentation of the advertisement. Once it has been verified that the player has crossed a threshold of participation, the player may be entitled to hear a song for free, or watch a video or read an article or a book etc., that otherwise might involve payment.

In an alternative embodiment, the player will have the option to record the song over the artist soundtrack, while playing the game. The player sees each word of the lyrics at the same time as it is sung by the artist. The player is enabled to forward the track with him/herself recorded over the original track to other players. This usage of the original track may or may not be charged to the player, depending on the arrangement with the owners of the soundtrack and the music publishers.

In another alternative embodiment, the words or icons will be part of an advertisement, where the advertisement can include bubbles or other shapes. The player presses the shape on the screen, for example or otherwise activates bursting in a specified order during the advertisement, in order to verify that the player is attentive to the advertisement. The player's actions will be recorded as with the lyrics game embodiment, and will provide feedback to the advertiser concerning the level of engagement and attentiveness of the player. If the player passes a certain thresh-hold, the player might be entitled to a benefit that may include free music, videos, electronic books, coupons, etc.

Also, if the advertisement is part of the game or the content (video, electronic book, etc.), the LyricsLegend game or other game can be played for advertising purposes, The game can continue as long as the player keeps tapping the bubbles or the icons that represent his/her participation. Once x number of bubbles has not been tapped, the song/video or content will stop. This exemplary stopping mechanism prevents the player from listening to a song without being engaged with the advertising at the same time. With this monitoring mechanism, the advertiser knows, in fact, that the player is engaged with the advertising while listening to the song.

There has thus been outlined, rather broadly, the more important features of the invention in order that the detailed description thereof that follows hereinafter may be better understood. Additional details and advantages of the invention will be set forth in the detailed description, and in part will be appreciated from the description, or may be learned by practice of the invention.

### BRIEF DESCRIPTION OF THE DRAWINGS

For a better understanding of the invention with regard to the embodiments thereof, reference is now made to the accompanying drawings, in which like numerals designate corresponding elements or sections throughout, and in which:

FIG. 1 is a schematic illustration of the opening screen, constructed in accordance with the principles of a preferred embodiment of the present invention;

FIG. 2 is a schematic illustration of the second screen: choosing between Training and Competition Mode, constructed in accordance with the principles of a preferred embodiment of the present invention;

FIG. 3 is a schematic illustration of the third screen: choosing the level of play, constructed in accordance with the principles of a preferred embodiment of the present invention;

FIG. 4 is a schematic illustration of the fourth screen: choosing a song from a list of songs: Twinkle, Twinkle has been chosen, constructed in accordance with the principles of a preferred embodiment of the present invention;

FIG. 5 is a schematic illustration of the fifth screen: the chosen song begins to play and the first 3 words of the lyrics show up in bubbles, constructed in accordance with the principles of a preferred embodiment of the present invention;

FIG. 6 is a group of schematic illustrations of various developments during the course of playing the game, constructed in accordance with the principles of a preferred embodiment of the present invention;

FIG. 7 is a schematic illustration showing a more difficult game with a high number of bubbles, constructed in accordance with the principles of a preferred embodiment of the present invention;

FIG. 8 is schematic illustration of the opening screen provided by the plug-in software for accessing game features, constructed in accordance with an alternative embodiment of the present invention;

FIG. 9 is schematic illustration of the opening screen for the Lyrics Legend game, constructed in accordance with an alternative embodiment of the present invention;

FIG. 10 is schematic illustration of the game-started screen for the Lyrics Legend game, constructed in accordance with an alternative embodiment of the present invention; and

FIG. 11 is schematic illustration of the current player's relative ranking screen for the Lyrics Legend game, constructed in accordance with an alternative embodiment of the present invention;

FIG. 12 is screenshot illustration of a Karaoke Legend embodiment, constructed in accordance with an alternative embodiment of the present invention;

FIG. 13 is a screenshot illustration of an advertising model embodiment for the Lyrics Legend game, constructed in accordance with an alternative embodiment of the present invention;

FIG. 14 is a screenshot illustration of a second step in an advertising model embodiment for the Lyrics Legend game, constructed in accordance with an alternative embodiment of the present invention;

FIG. 15 is an opening schematic illustration of a massively parallel competition, constructed in accordance with an alternative embodiment of the present invention;

FIG. 16 is a schematic illustration of the hint screen of a massively parallel competition, constructed in accordance with an alternative embodiment of the present invention;

FIG. 17 is a schematic illustration of the results screen of a massively parallel competition, constructed in accordance with an alternative embodiment of the present invention; and

FIG. 18 is a schematic illustration of an alternative embodiment of the Lyrics Legend embodiment.

### DETAILED DESCRIPTION OF AN EXEMPLARY EMBODIMENT

The principles and operation of a method and an apparatus according to the present invention may be better understood with reference to the drawings and the accompanying description, it being understood that these drawings are given for illustrative purposes only and are not meant to be limiting.

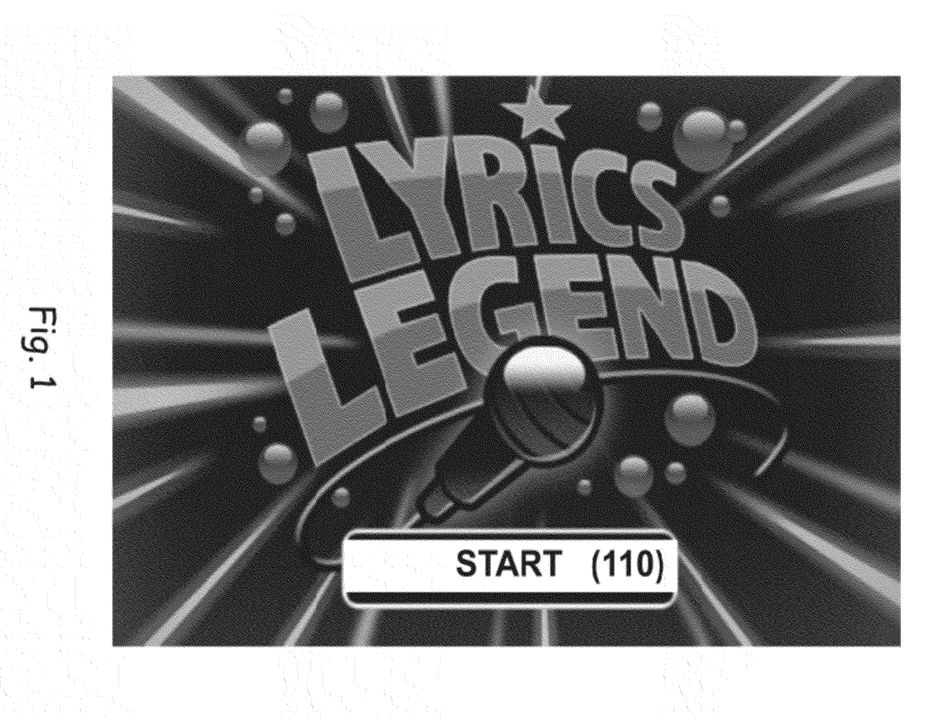

FIG. 1 is a schematic illustration of the opening screen, constructed in accordance with the principles of a preferred embodiment of the present invention. A player clicks the “start” button 110.

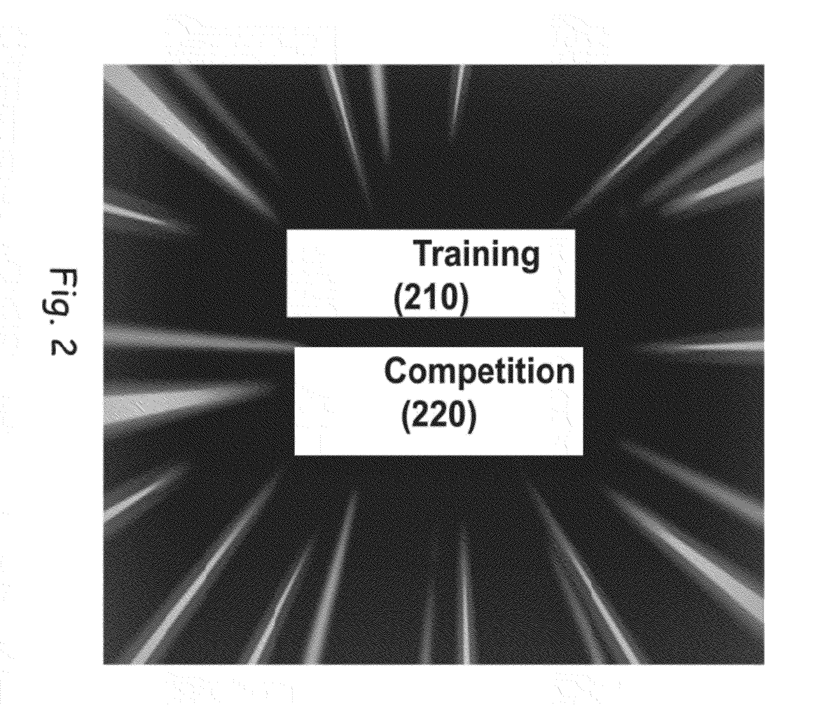

FIG. 2 is a schematic illustration of the second screen: choosing between Training Mode 210 and Competition Mode 220, constructed in accordance with the principles of a preferred embodiment of the present invention.

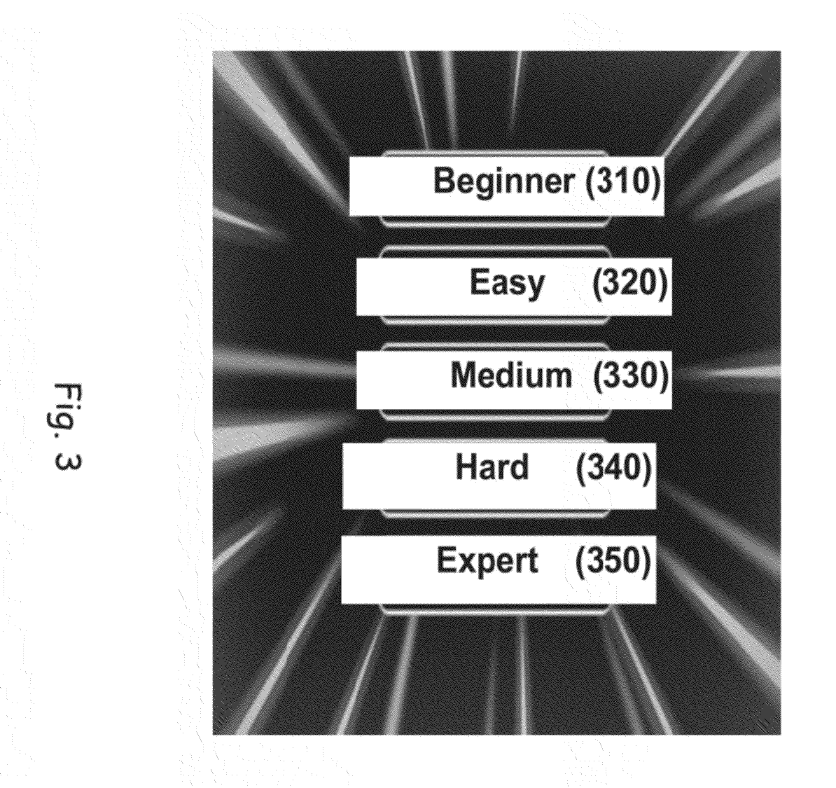

FIG. 3 is a schematic illustration of the third screen: choosing the level of play, constructed in accordance with the principles of a preferred embodiment of the present invention. The exemplary levels are Beginner 310, Easy 320, Medium 330, Hard 340 and Expert 350.

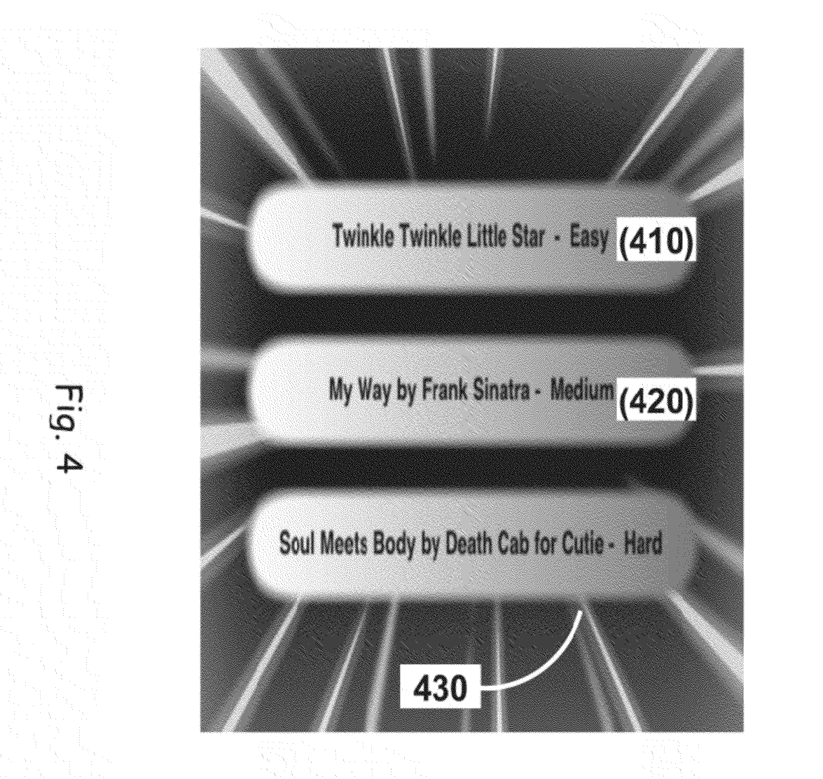

FIG. 4 is a schematic illustration of the fourth screen: choosing a song from a list of songs: The exemplary choices are Twinkle, Twinkle Little Star—Easy 410; My Way by Frank Sinatra—Medium 420 and Soul Meets Body by Death Cab for Cutie—Hard 430, constructed in accordance with the principles of a preferred embodiment of the present invention.

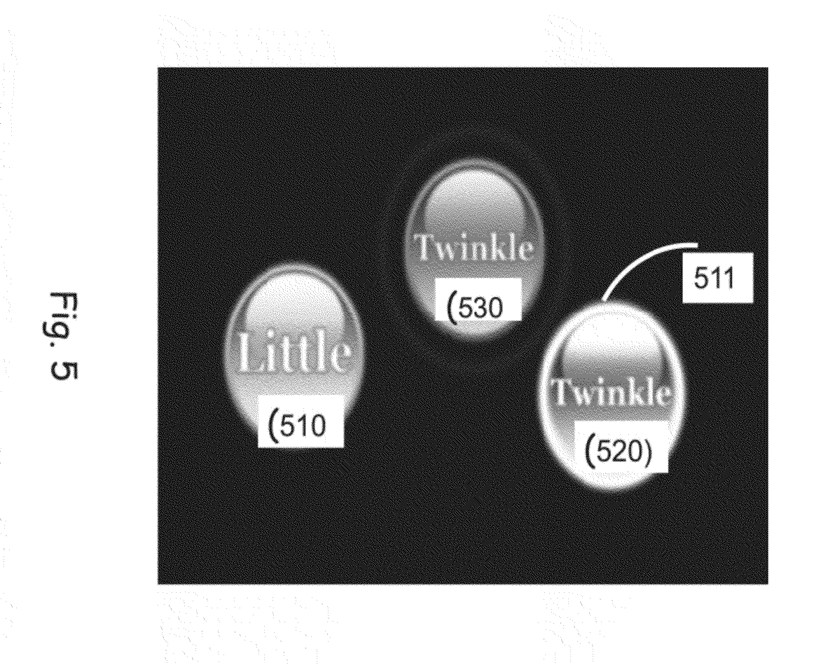

FIG. 5 is an exemplary schematic illustration of the fifth screen: the chosen song begins to play and the first 3 words of the lyrics show up in bubbles, constructed in accordance with the principles of a preferred embodiment of the present invention. Twinkle, Twinkle has been chosen. As the song begins to play the first 3 words of the lyrics show up in bubbles 510, 520 and 530. The first one that the player needs to click with a finger or a mouse is marked in with a white circle 511 and the second one is already marked with a dark circle 521.

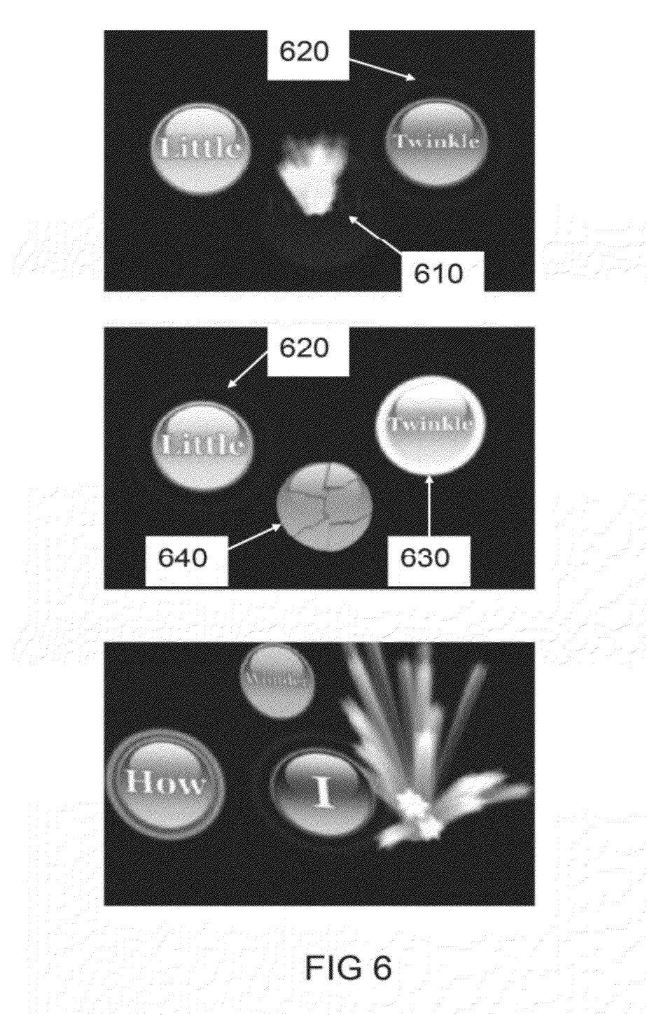

FIG. 6 is a group of schematic illustrations of various developments during the course of playing the game, constructed in accordance with the principles of a preferred embodiment of the present invention. Once a bubble is clicked in the correct order, the bubble will burst like fireworks 610. In learning Mode, the next word to click is already marked 620 with a dark circle. The dark circle needs to be clicked only when it starts to shrink and turns white, i.e., when it is the same size as the bubble 630. If the player missed clicking on a bubble, it turns black and crashes 640. The next word, in this case “Little,” gets a reminder that it is the next to be clicked after the other “Twinkle,” which is now in a white circle 630—meaning—click me now! And so the game continues.

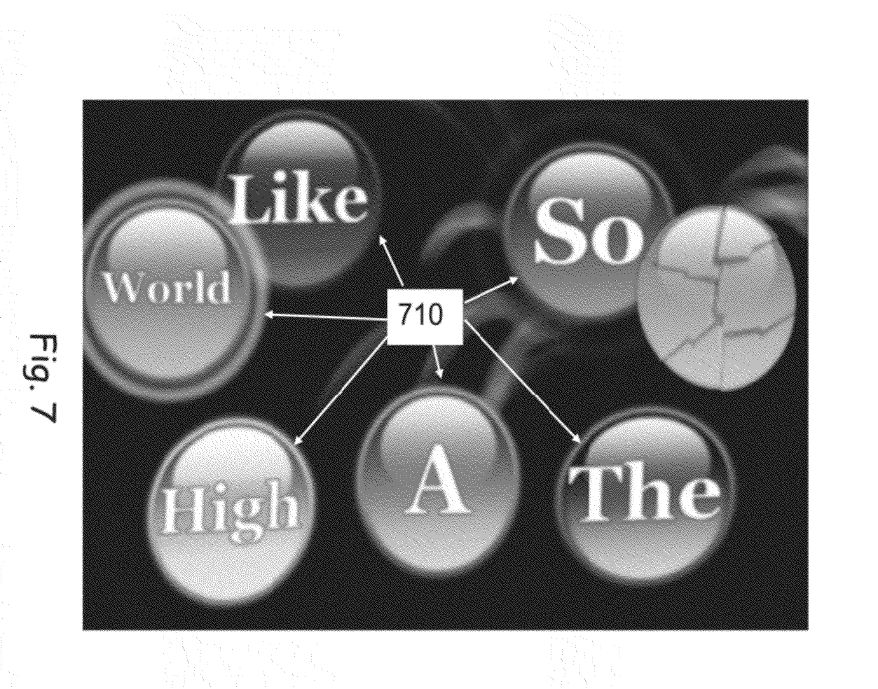

FIG. 7 is a schematic illustration showing a more difficult game with a high number of bubbles, constructed in accordance with the principles of a preferred embodiment of the present invention. At the end of the game, and while the game is going, players get scores on how accurate they were, and they are compared on city level, country level and world level to other players. The difficulty level is determined by the number of bubbles present and takes you from 3 bubbles to 6 bubbles 710, where the mastering of the lyrics and the reaction, the focus and the identification level needs to be very high.

In an alternative embodiment a method is disclosed for playing an online Lyrics Legend game by at least one player with a graphic player interface (GUI) over an electronic network. The method includes selecting a recorded song to playback for use in the game, displaying the words of the lyrics of the song one line at a time and encircling each of the displayed words of the lyrics in circular “balloons” that move around. The method also includes selecting and arranging of the lyrics by the player according to their correct order by “dragging and dropping,” while the song is playing, getting points by the at least one player for selecting each word in the right place and getting an extra point by finishing the current whole line and disappearing of the completed line and appearing of the next line, wherein the at least one player is playing against one of at least one friend, his/her entire country and the whole world.

### Lyrics Legend

Each word of the lyrics line played will be circled in variously colored “balloons” that move around in the manner of slightly lighter-than-air balloons. While the song is playing the competing players attempt to arrange the lyrics into correct order for a particular song using the computer mouse and GUI in the standard “drag and drop” technique, for example. They get points for clicking each word in the right order, in the right time (how close they are to the exact time in which the artist was singing this word) and for identifying duration (when the artist sings a word more then one second, they should leave their finger on the word for the duration of the time the artist sings this word). They get an extra point if they finish the whole sentence, or more then x words in a row. When a word in a bubble has finished its role (either burst or missed), another bubble will appear instead of it. The player can play against one or more friends, against his/her all country or against the whole world.

A recorded song is played on a player's computer screen or mobile phone screen, for example. Each word of a current line of the lyrics moves around randomly on the screen, as if it was a “helium balloon.” The object of the game is to “pop” the bubbles in the right order and at the right time, i.e., within several milliseconds before or after the singer in the recording sings the particular word. Whenever the last word balloon of the line pops, the words from the next line appear and start moving around. Each player gets scores based on the correct order, timing and completion of a full line, line-by-line. Additional points are received for pressing the bubbles/words for the correct duration of the sung word.

Each song is part of a playground for international competition. Increasingly difficult levels are established to achieve higher scores. Settings for increasing the speed of the moving bubbles on the screen are used to enable even higher scoring levels. More bubbles may also be added, for example, by displaying the words for multiple lines of the song simultaneously. Players can buy and download the Lyrics Synch plug-in and the recordings of the songs.

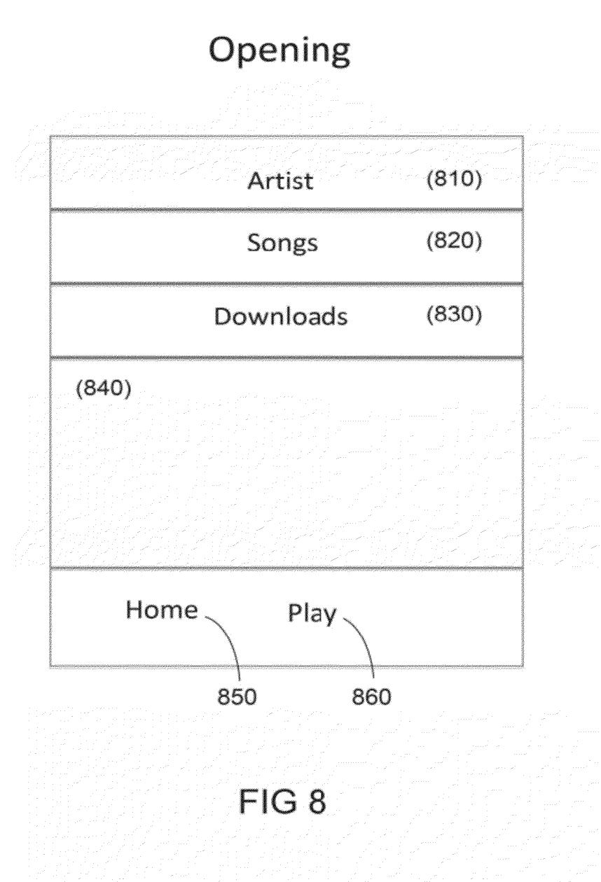

FIG. 8 is schematic illustration of the opening screen provided by the plug-in software for accessing game features, constructed in accordance with one embodiment of the present invention. A player can enter an Artist 810 and then scrollable songs of that artist will appear in the display area 840, where one of these will be selected for the game. Alternatively, the player can enter a particular Song 820 and a scrollable listing of various available artists recordings of that song will appear in the display area 840, where one of these will be selected for the game. Downloads of recordings 830, or other downloads, can also be ordered. The player can return to a “Home Page” 850 or can start to “Play” 860 by clicking the corresponding button.

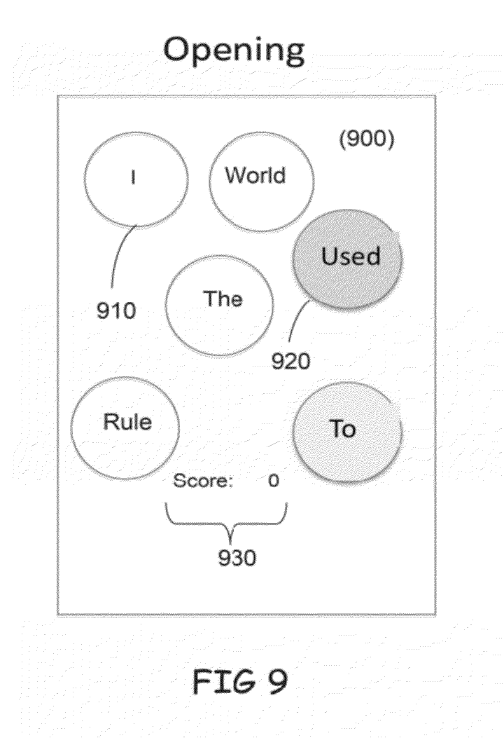

FIG. 9 is schematic illustration of the opening screen for the Lyrics Legend game, constructed in accordance with one embodiment of the present invention. When the player clicks the Play button the screen 900 of FIG. 9 appears. The circled “balloon” words of the first line of the song “I used to rule the world” are shown. The “balloons” are moving around randomly. When the singer sings the word “I” 910, the player is supposed to click that “balloon,” within a preset number of milliseconds of the word being sung. Similarly the player then clicks the word “used” 920, etc.

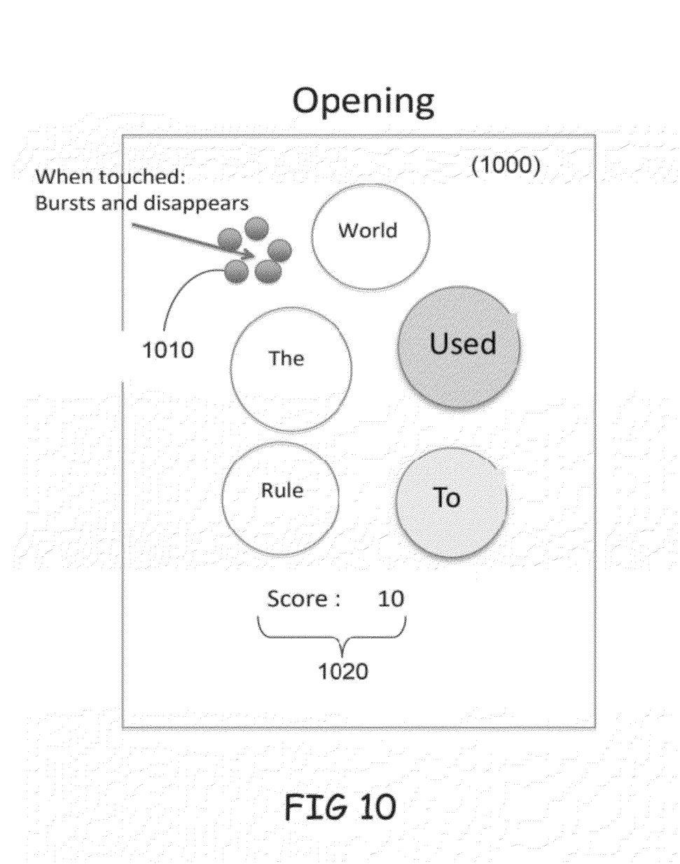

FIG. 10 is schematic illustration of the game-started screen for the Lyrics Legend game, constructed in accordance with one embodiment of the present invention. When the player clicks the first word of the line, “I,” the word bursts into multiple small pieces 1010 on the screen 1000 of FIG. 10 and then completely disappears. The players score then changes fro “0” to “10” 1020, for example, as shown.

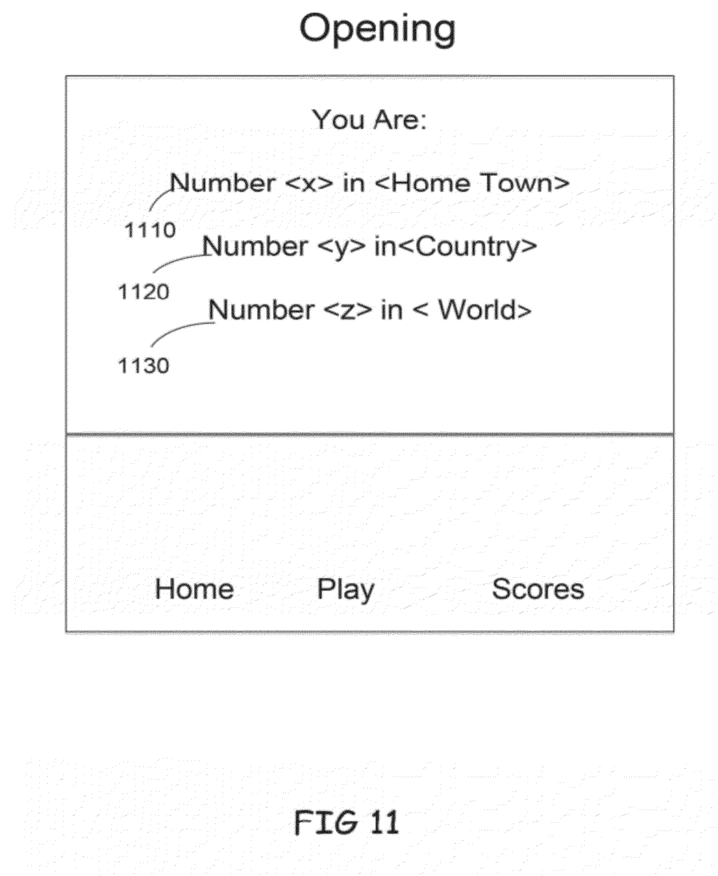

FIG. 11 is schematic illustration of the current player's relative ranking screen for the Lyrics Legend game, constructed in accordance with one embodiment of the present invention. The players ranking in his Home Town 1110, his country 1120 and in the world 1130 are shown.

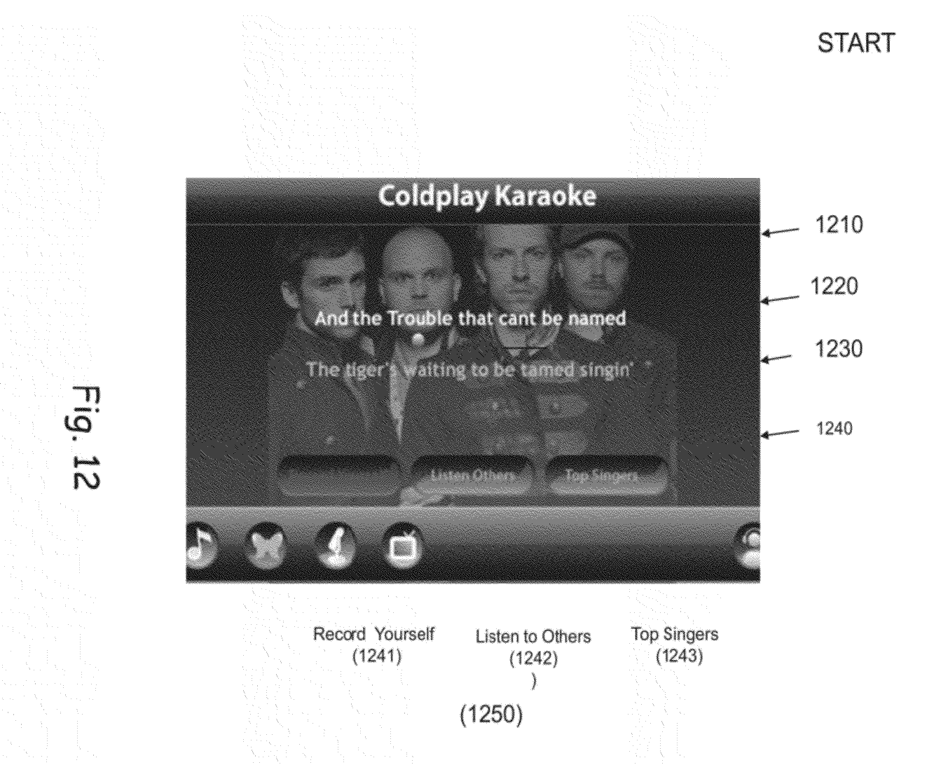

FIG. 12 is screenshot illustration of a Karaoke Legend an exemplary alternative embodiment, constructed in accordance with one embodiment of the present invention. Karaoke Legend will bring the Karaoke experience to the handset of the present invention, taking advantage of the handset unique capabilities provided for the Lyrics Legend game and new possible business processes to develop an innovative approach to Karaoke.

A player records himself on the handset, using a background music file and lyrics with instructions. FIG. 12 shows an image of the musical group Coldplay 1210. The player will be able to edit the song on the handset. The player will be able to upload the song to a Website where the song will be presented under his/her name and other players can listen to that song. Players will be rated by other players. A line from the lyrics of the

Coldplay song “Clocks” 1220 is shown. The next line 1230 is also shown, but with less brightness. Clickable buttons include: Record Yourself;” Listen to Others;” and a selectable list of “Top singers.” There is also a lower toolbar of various functions 1250.

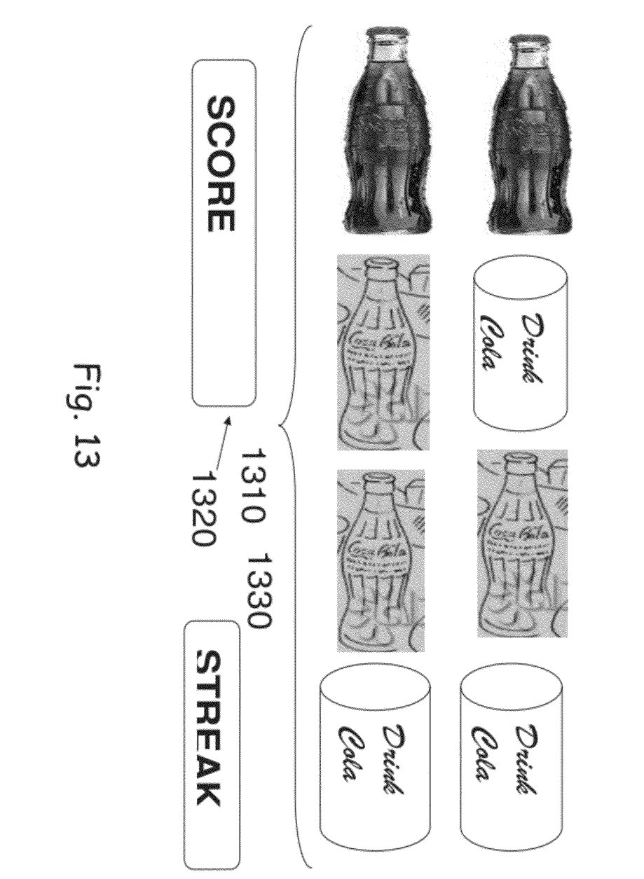

FIG. 13 is a screenshot illustration of an advertising model embodiment for the Lyrics Legend game, constructed in accordance with an alternative embodiment of the present invention. The words or icons will be part of an advertisement, where the advertisement can include bubbles or other shapes 1310. The player's score 1320 any consecutive streak 1330 are shown.

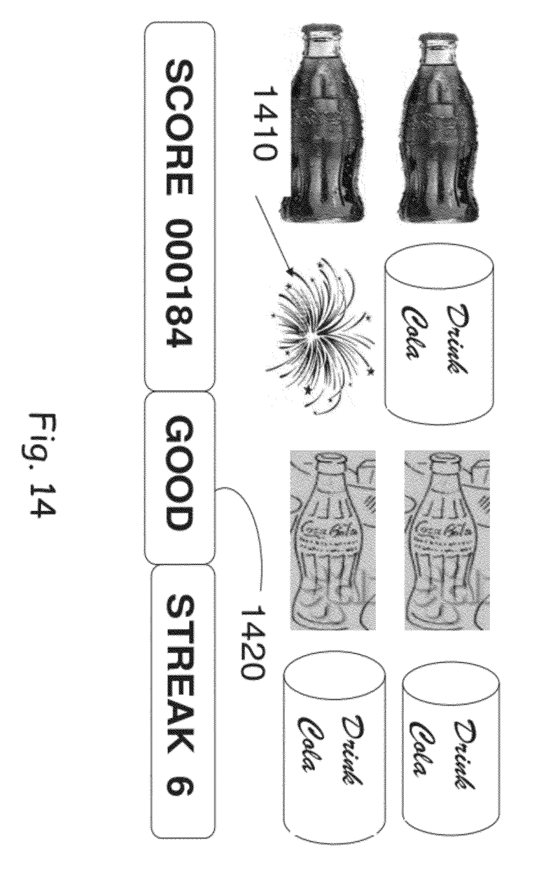

FIG. 14 is a screenshot illustration of a second step in an advertising model embodiment for the Lyrics Legend game, constructed in accordance with an alternative embodiment of the present invention. The player presses one of shapes 1310 on the screen, for example, or otherwise activates bursting 1410 in a specified order during the advertisement, in order to verify that the player is attentive to the advertisement. The player's actions are encouraged 1420 and will be recorded as with the lyrics game embodiment, and will provide feedback to the advertiser concerning the level of engagement and attentiveness of the player. If the player passes a certain thresh-hold, the player might be entitled to a benefit that may include free music, videos, electronic books, coupons, etc.

A method for allowing content to be played for free by verification of the engagement with advertising in real time and blocking the content if no interaction is made. The present embodiment allows consumption of content, such as entertainment (music-videos) or newspaper articles or any content that needs monetization by pre-middle-end advertising monitored in real time through feedback from the player using a touch screen or a keyboard.

For example, before playing a song for free or watching a TV series, the player will need to interact with the advertising utilizing the touch screen or the key pad. The interaction can be pressing icons or keys in different positions, such that corresponding signals are sent back through the Internet to verify that the player is attentive and is engaged with the ad. This verification can be at the beginning, middle, throughout or at the end of the content.

Also for the embodiment of the advertising using bubbles: If one plays LyricsLegend or any other game for advertising purposes, the game can continue as long as the player keeps tapping at the bubbles or the icons that represent his/her engagement. Once x amount of bubbles have not been tapped, the song/video or content will stop. This is a mechanism, for example, to prevent the player from listening to a song without being engaged with the advertising at the same time. With this monitoring mechanism, the advertiser knows that the player is engaged with the advertising while listening to the song.

In another alternative embodiment players are enabled to sell their singing versions and may be awarded revenue from selling their song. All arrangements are based on legal licensing of the rights from the music publishers, who are motivated by additional sources of revenue based on the added means of exposure.

In yet another alternative embodiment each player may be listening to a radio station with the ‘kind’ of music they like. It can be multiple private lists each player prepares. The player can effectively switch ‘playlists.’

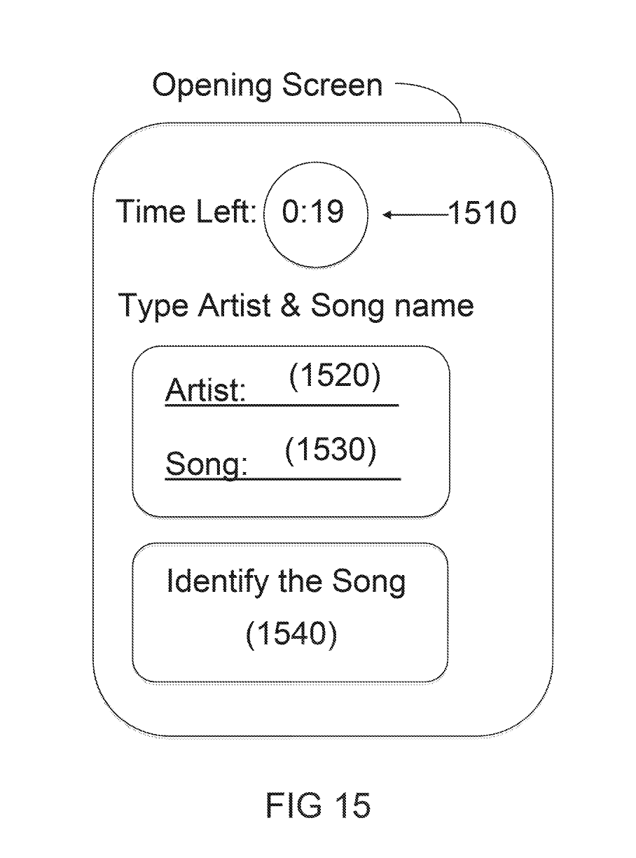

FIG. 15 is an opening schematic illustration of a massively parallel competition, constructed in accordance with an alternative embodiment of the present invention. The basis of the game is identifying the artist 1520 and the song 1530 as fast as the player can relative to others who compete on the same question at the same time. A player gets into a Uniform Resource Locator (URL) or a page in an application. Every x minutes, for example every 1 minute, a question is posed and the players need to answer as fast as possible. The player presses the “Identify the song” button 1540 to enter his answers.

The time left 1510 is shown.

The same music stream is sent to all players at the same time. The number of players can be in the thousands, from all over the world. As with the Lyrics Legend embodiment, lyrics will be shown while the sample is playing, thereby enabling social network activities related to the song, such as showing map locations of other players, other people that may be listening to the songs and other translation and other songs by the same artist.

Scoring is based on speed and accuracy. The less time it takes to ID the song the better. There is a penalty for a wrong selection and only one selection per game segment is allowed. An exemplary game can be for 30 minutes, showing 60 songs, one song every 30 seconds.

The best, most accurate and fastest player will receive a reward, for example a free music download.

### Game Rules:

Every specified time period, for example 1 minute, a quiz will start. The present embodiment is based on music, but the invention can implement any form of quiz. A player logs into the game, such that the system knows that they are in the system, and has their identification. As many players can log in the system.

In our first game: music will start to play, players need to identify the song in 30 seconds. In the beginning there will not be any clues but at a later stage, for example, after 15 sec, a hint or a multiple choice can appear to help the player get an answer.

Players will get points according to how fast they solved the quiz.

Other quiz examples can be a line from lyrics of the song that the player needs to identify, or a picture of an artist that the player needs to identify, or from the music world, a line from a book, or a picture of a place that players needs to identify while competing with others. When the allocated time passes a new quiz will start

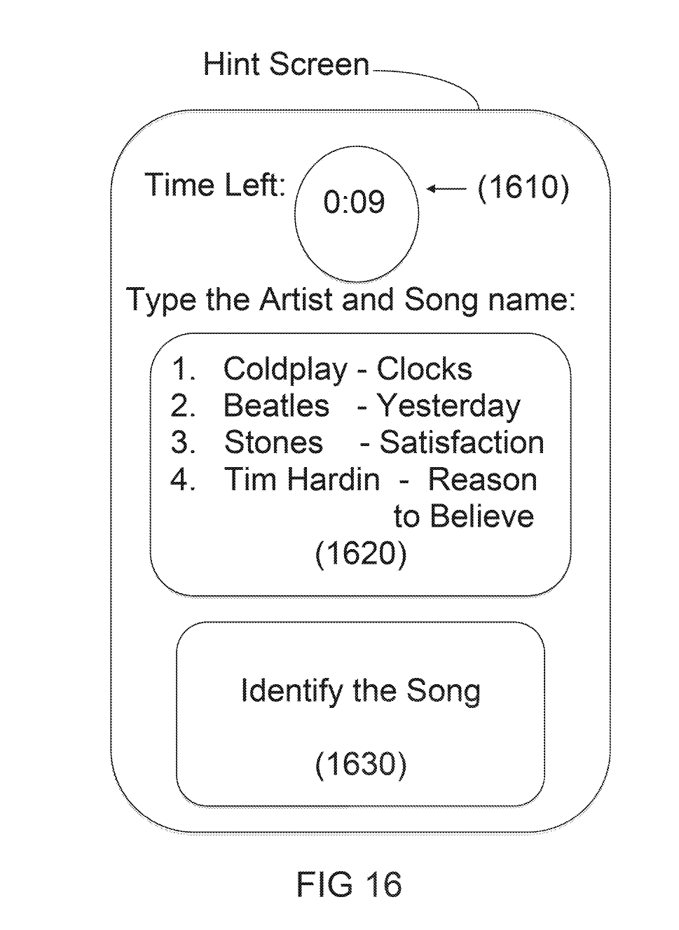

FIG. 16 is a schematic illustration of the hint screen of a massively parallel competition, constructed in accordance with an alternative embodiment of the present invention. Each question is a 30 second sample of a song randomly elected from the database of the present invention, and in this second “hint” stage the players can choose the correct name from a list presented of 4 titles 1620, for example. The artist may be a single performer or a group. Again, the time left 1610 is shown and the player presses the “Identify the song” button 1630 to enter his answer.

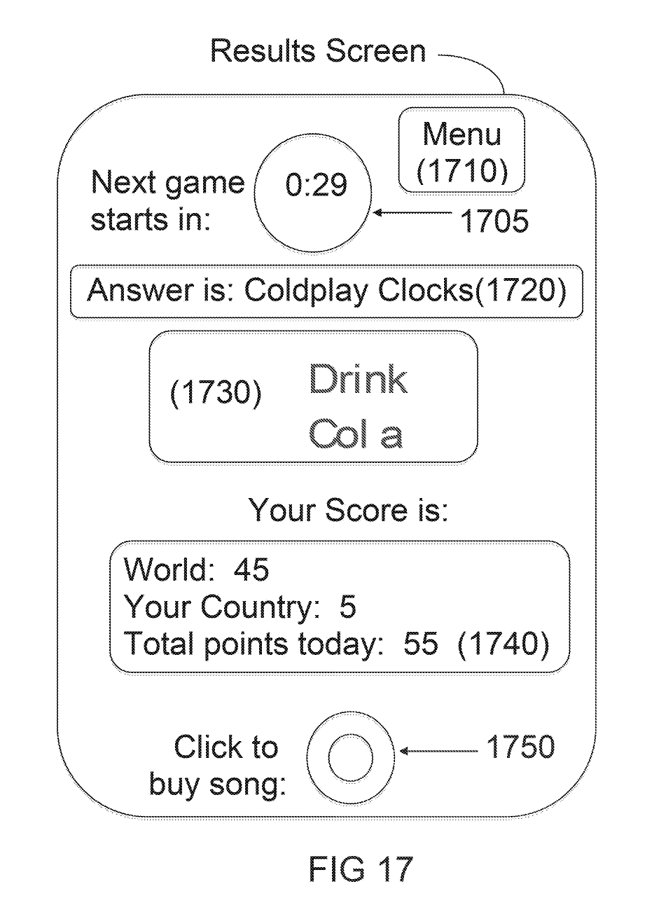

FIG. 17 is a schematic illustration of the results screen of a massively parallel competition, constructed in accordance with an alternative embodiment of the present invention. Players can accumulate points by the hour, day or month and compete for virtual or physical prizes. Again, the time left 1510 is shown. The first x get points according to a sliding scale, the rest get a message with their relative result in their country and in the world, for example—number 4 in Turkey, 457 in the world.

The primary objectives of the game are:

1) engage players for long periods of time;

2) expose the players to advertising 1730; after a specified time, for example 30 sec, players can buy the song, or the book or any relevant merchandize, as well as get an advertisement on their screen;

3) players can buy any of the game music tracks with a click by “dropping” it with a click to a wish list; and

4) players can buy a stream of the entire game as a playlist stream so they can listen to later from an audio or audio/video list.

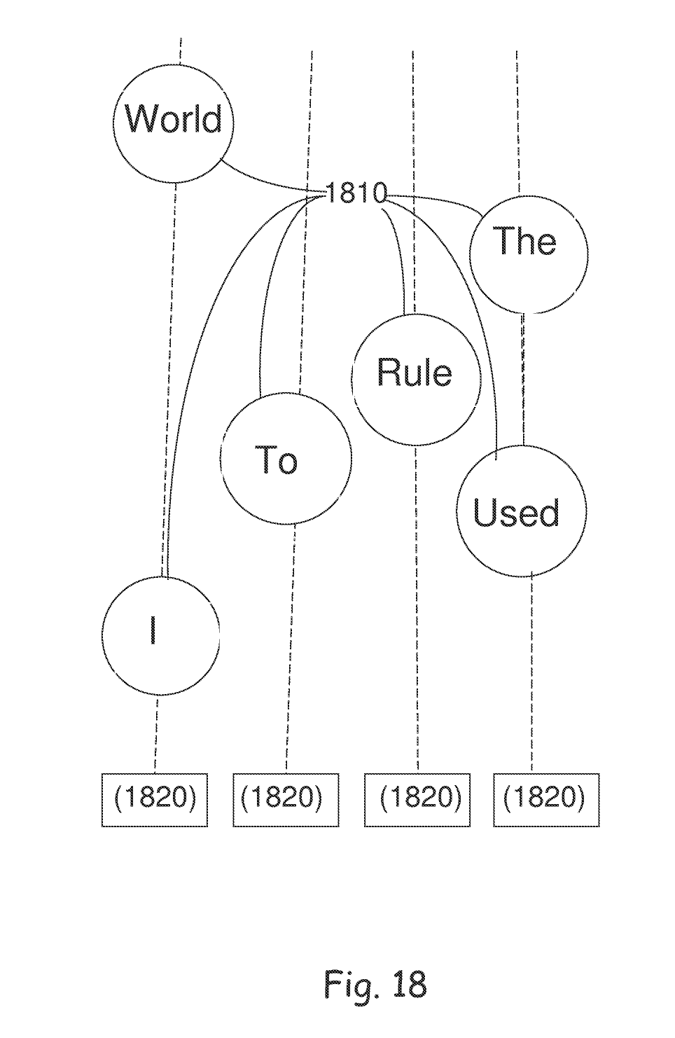

FIG. 18 is a schematic illustration of an alternative embodiment of the Lyrics Legend embodiment of FIG. 5, constructed in accordance with the principles of a preferred embodiment of the present invention. The bubbles of this embodiment 1810 float from top to bottom. The player preferably pops bubbles 1810 when they impact the base 1820. When the word in the song is sung by the artist for more than a specified number of seconds, the player is supposed to press for a corresponding extended period of time.

The complexity of the game depends on the arrangement of bubbles 1810 and how fast they travel.

Having described the present invention with regard to certain specific embodiments thereof, it is to be understood that the description is not meant as a limitation, since further modifications will now suggest themselves to those skilled in the art, and it is intended to cover such modifications as fall within the scope of the appended claims.

We claim:

1. An electronic game playable upon an electronic device having a display screen, said game comprising the following steps:
a) displaying each word of a song lyric, enclosed in a separate outlined shape, upon a display screen;
b) initiating playback of a prerecorded song;
c) allowing a user to: select the lyrics word in order, while each word is played back; and
d) rating a user's performance of step (c).

2. The game of claim 1, wherein said selection of lyrics by a user in step (c) is performed using one of the following: a mouse, a keyboard, a touch-screen, a joystick, a computer-associated writing tool, and a button.

3. The game of claim 1, wherein said selection of lyrics by a user in step (c) is performed using voice recognition software.

4. The game of claim 1, wherein upon performance of step (c) of selecting each lyrics word, the visual appearance of said word is changed.

5. The game of claim 4, wherein said outlined shape has the appearance of a bubble, and after selection of said word, the bubble appears to burst.

6. The game of claim 1, wherein said game is adapted to be played upon an electronic device selected from: PC, a laptop, a tablet, a cellular phone, and a handheld multimedia music player.

7. The game of claim 1, wherein said step a) of displaying each word of a song, comprises displaying several words at a given moment, and displaying additional words as playback of said song continues.

8. The game of claim 7, wherein said lyric words are displayed in random order, and not in the order they appear in the playback.

9. The game of claim 1, wherein said game is adapted to be played simultaneously by a plurality of users.

10. The game of claim 1, wherein a user is allowed to select a song of interest.

11. The game of claim 1, wherein each outlined shape includes a song lyric word, and its translation into another language.

12. The game of claim 1, wherein advertising material is included in the content of said game, in a manner selected from one or more of the following: the separate outlined shape surrounding the lyrics word has a recognizable product shape; upon selection of each of the lyrics words, an advertisement takes the place of each word; and the song is an advertisement song.

13. The game of claim 12, wherein a user is provided with a redeemable coupon after playing said game.

14. The game of claim 1, wherein visual indication is displayed to indicate which is the next word for selection.

15. The game of claim 1, wherein the words displayed in step a) are in motion upon the display screen while the game is played.

16. The game of claim 1, wherein a user is required to drag and drop the correct words in the order they appear in the song playback.
